(19) United States
(12) Patent Application Publication
(10) Pub. No.: US 2008/0186130 A1
(43) Pub. Date: Aug. 7, 2008

(54) KEY MANAGEMENT SYSTEM

(76) Inventors: Arthur A. Trevino, Lancaster, SC (US); Shane Farris, Charlotte, NC (US)

Correspondence Address: F. RHETT BROCKINGTON, 10613 KENNEL LANE, CHARLOTTE, NC, 28277, US

(21) Appl. No.: 11/769,329

(22) Filed: Jun. 27, 2007

Related U.S. Application Data
(60) Provisional application No. 60/816,715, filed on Jun. 27, 2006.

(51) Int. Cl. G08C 19/00

(52) U.S. Cl. 340/5.2

(57) ABSTRACT

An asset management system includes a distributed network of hierarchical controllers to manage the dispensation of assets, such as keys and the like, where the an asset is attached to an electronic fob, and the fobs are removably connected to a connection port. The hierarchical controllers are a plurality of system microprocessors and multiplexers that control a plurality of panel controllers, which in turn control a plurality of fob controllers, which in turn are physically and electronically interfaced with a plurality of fobs. The asset management system specifically manages a unique physical location of each fob on a panel. The system microprocessors are in communication with a host computer, which in turn can be in communication with other computers and other asset management systems. The system microprocessor can also control subsequent system microprocessors through a master-slave control hierarchical system.

### CROSS REFERENCE TO RELATED PATENT APPLICATION(S)

This present non-provisional patent application claims priority to U.S. Provisional Patent Application Ser. No. 60/816,715 filed Jun. 27, 2006, and entitled “KEY MANAGEMENT SYSTEM”, which is incorporated in-full by reference herein.

### BACKGROUND OF THE INVENTION

1) Field of the Invention

The invention relates to apparatus and method for keeping track of assets, such as keys or small items typically stored on a panel, and more particularly to a distributed system and method that uses fobs connected to assets to electronically and physically connect to connection ports on the panel, where the connection ports are controlled by hierarchical controllers.

2) Prior Art

Effective asset management requires that a number of individual assets can be securely stored when not in use, but one or more of the assets, such as keys and the like, can be made available to an authorized user in an efficient manner. Enhanced capabilities of asset management systems include tracking of assets that are in use or missing, as well as the ability to generate reports about activity relating to access of the assets and/or the locked areas and devices unlocked by the keys. Asset management systems enable the administration of the use of keys for a large fleet of vehicles, e.g., at a car dealership. The dealership expects the system to assist in permitting only authorized individuals, e.g., proctors of the keys, salespersons, mechanics, managers, etc., to have access to vehicles in its possession, but it does not wish to impede these authorized individuals from conducting business with cumbersome security measures. Typically, vehicle keys are maintained in a centralized location (e.g., the dealership showroom). In today's larger dealerships, returning from the sales lot to the showroom each time a different key is needed poses a real inconvenience. Therefore, a salesperson may try to guess all of the vehicles that a sales prospect may be interested in, and then take the keys to these vehicles. The keys may not be returned to the centralized location for some time, because the salesperson is busy or because the salesperson gives the keys to another salesperson that is seeking them. As a result, some keys may be “out of circulation” for an extended period, even though they may not be in actual use. Some centralized systems are as simple as a key-board having hooks on which the keys are hung, thus providing a visual indication of which vehicles are available on the lot based on which keys are present on the board. Another centralized system requires each individual seeking access to login through an attached computer with an ID and a password. Authorized individuals are provided access to a secure drawer with a compartment assigned to the keys for each vehicle in the dealership's inventory. This system records who removes a key from the drawer, the time the key was removed, and the time it was returned, based in part on an electronic identifier attached to each vehicle's keys.

In another approach, the keys are securely stored at or near each parked vehicle. The keys to each vehicle (or at least the ignition key) are secured in a locked key container when not in use. For example, each vehicle can be outfitted with a key box or key container having a conventional lock accessed by a conventional key. A dealership's collection of key containers might be keyed alike, or might require a small number of different keys.

For example, a conventional key management system for controlling access to vehicle keys can includes a key set, a key container and an electronic access device. The key set includes vehicle keys to a particular vehicle and a key tag associated with the vehicle keys having an electronically readable identifier. The key container has a key set storage area secured by an electronic lock and a circuit that detects when the key set is stored in the key set storage area. The access device is carried by a user to access the key container, and has a memory that is updated with the identifier of the key tag when the key container is successfully accessed.

A problem with the current art where each asset, such as a set of keys, has a known location managed by a host computer system, is that the system is not distributed and is not hierarchical in nature. Therefore, the system is relatively difficult to maintain and is relatively inextensible. Another panel of keys cannot be simply added, but typically requires that the entire system be re-wired or at a minimum re-configured. Also, most key management systems require that the key set be returned to a specific drawer or container, and there is a good chance that the user will eventually return the keys to the wrong key containers.

Other prior art deficiencies are that systems, which employ a plurality of one wire proprietary identification devices and associated transceivers, are limited in the speed in which the devices can be accessed, since they are serially connected. These systems are difficult to assemble and test. Also, a serial assembly is difficult to manage and troubleshoot if there is a technical problem, especially a system having many fob locations. A further limitation to a serial system is chaining multiple cabinets together with an electrical communication cable. In scenarios where the cabinets are decentralized, this would present an untenable scenario for the communication between all of the proprietary devices, as wires would be have to be strung to each of the cabinets.

It would be advantageous to provide a key management system that addresses the drawbacks of the prior systems.

### SUMMARY OF THE INVENTION

The present invention includes a distributed network of hierarchical controllers to manage assets, such as keys and the like, which are attached to electronic fobs, where the fobs are removably connected to connection points mounted on a plurality of panels. The system includes a host computer which controls a system microprocessor through a transmitter, which control the plurality of panel controllers, which in turn control a plurality of fob controllers, which in turn are physically and electronically interfaced with a plurality of fobs through USB form factor connection points. All controller functions and communication functions are managed through high speed serial communications busses in communication with the host computer, either wired or wireless. Assets and the like (i.e. keys) are physically attached to the fob. The fobs have a digital memory component requiring no battery, for instance flash memory devices that can be fitted on a keychain, and carried around in one's pocket. Hierarchical controllers provide a system for defining a unique fob location on multiple panels full of fobs. The host computer and system microprocessor can be a wireless or wired network. The host computer, system microprocessor and assets under its control can be literally located anywhere within the communication range of the network, so that when an asset, such as a key, is removed from a cabinet in one car dealership, another dealership across the country can keep track of all the keys in the network.

The present invention provides a distributed architecture that takes all previous methodologies further in terms of efficiency in communications speed between multiplexed high speed serial communications bus connections and the system microprocessor without the necessity for expensive proprietary electronic devices. Eliminating proprietary identification devices reduces dependency from a sole source and provides opportunities for cost efficiencies. The invented distributed architecture enables a unique backplane assembly with virtually no degradation in communication speed between a uniquely identified connection port position and the host computer. The system increases the read speed of a large number of devices in a given system by at least a factor of four. The invented system is modular and can be expanded in a direct modular fashion using non-proprietary cable, transceivers and high speed industry standard communications bus interfaces. There is an increase in overall system integrity, reliability, testability and ability to maintain and troubleshoot.

Furthermore, the invention is a method for using the invented asset management system. The method of asset management system includes four steps: a) providing a method of entering assets, such as a set of keys, into the management system; b) providing a method of removing an assets; c) providing a method of returning an asset; and d) providing a method of deleting assets from the management system

The method for removing selected assets, such as a set of keys, includes the steps of: providing an asset management system including an apparatus wherein all controller functions and communication functions are managed from a high speed serial communication interface, wired or wireless in communication with a host computer, wherein an asset is attached to a fob where the fob has the capacity for gaining and retaining a unique identification (UID) and, where the system, through scanning, can determine if the fob is connected to an Inter-Integrated Circuit (I2C) bus and the asset is available, or if the fob has been removed and the asset is not available; logging onto the asset management system therein gaining access to a database that has a visual listing of a plurality of assets, a description of the assets and a status as to their availability, a means of designating that an available asset is selected for collection, and a means of determining that a removed asset is returned; selecting one or more available assets, therein designating that the accompanying fob is to be removed; issuing a position enunciation over the I2C bus, such as an audible or visible signal, that indicates a physical location of a selected available asset; collecting the selected available asset, whereupon the database is updated that the asset is no longer available and turning off the particular position enunciator, or if the wrong asset is collected, issuing an error removal enunciation until the error condition is corrected; and repeating the collecting step until all the selected available assets are collected.

The method of returning the assets further includes the steps of: providing a local reader in communication with the host computer, where said local reader can determine the unique identifier (UID) of the fob; reading the returning fob's UID, matching the fob with the asset in the database, and generating the position enunciation for the asset to be returned; issuing the position enunciation over the I2C bus that indicates the physical location for the returning asset; receiving the returning asset, whereupon the database is updated that the removed asset is returned, the asset is now available for selection, and turning off the particular position enunciator, or if the returned asset is returned to the wrong position issuing an error return enunciation until the error condition is corrected; and repeating the receiving step until all the returning assets are received.

### BRIEF DESCRIPTION OF THE DRAWINGS

The present invention is illustrated and described herein with reference to the various drawings, in which like reference numbers denote like method steps and/or system components, respectively, and in which:

FIG. 1 is diagrammatic view of a multi-panel system, where each panel has a plurality of fobs;

FIG. 2 is a schematic illustrating the distributed hierarchical relationship of a panel controller, a plurality of fob controllers, and a plurality of connection ports on a panel;

FIG. 3 is a diagrammatic view of an electronic fob having a key ring;

FIG. 4 is a flow chart of the method for removing an asset; and

FIG. 5 is a flow chart of the method for returning an asset.

### DESCRIPTION OF THE INVENTION

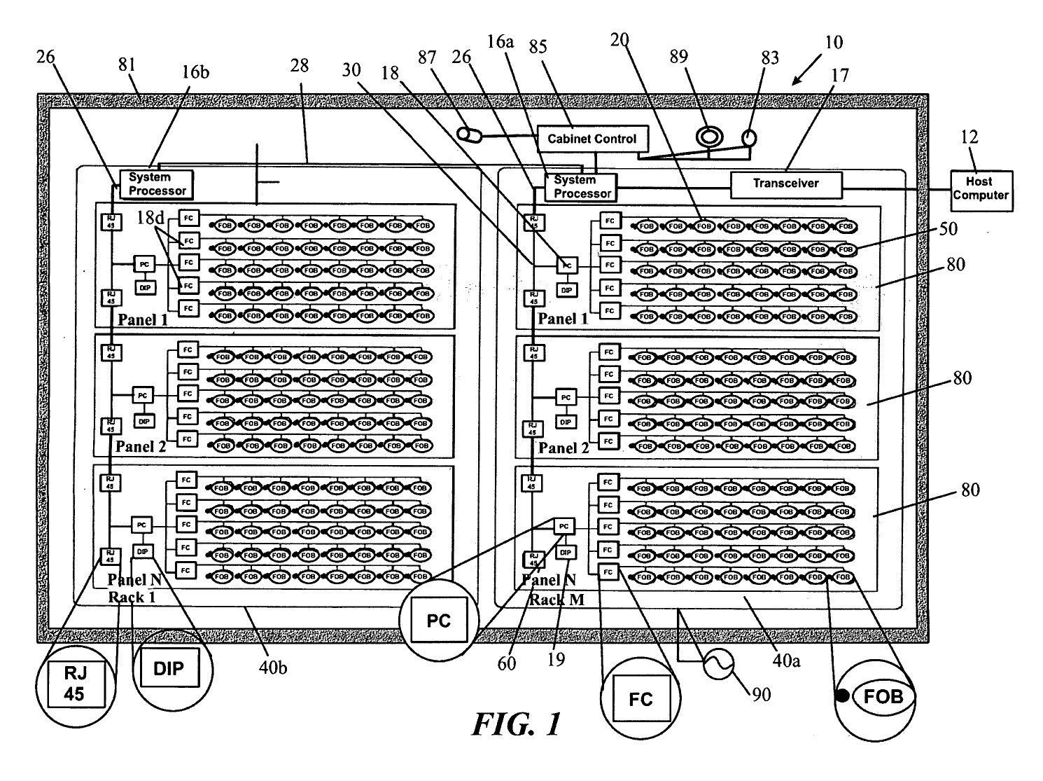

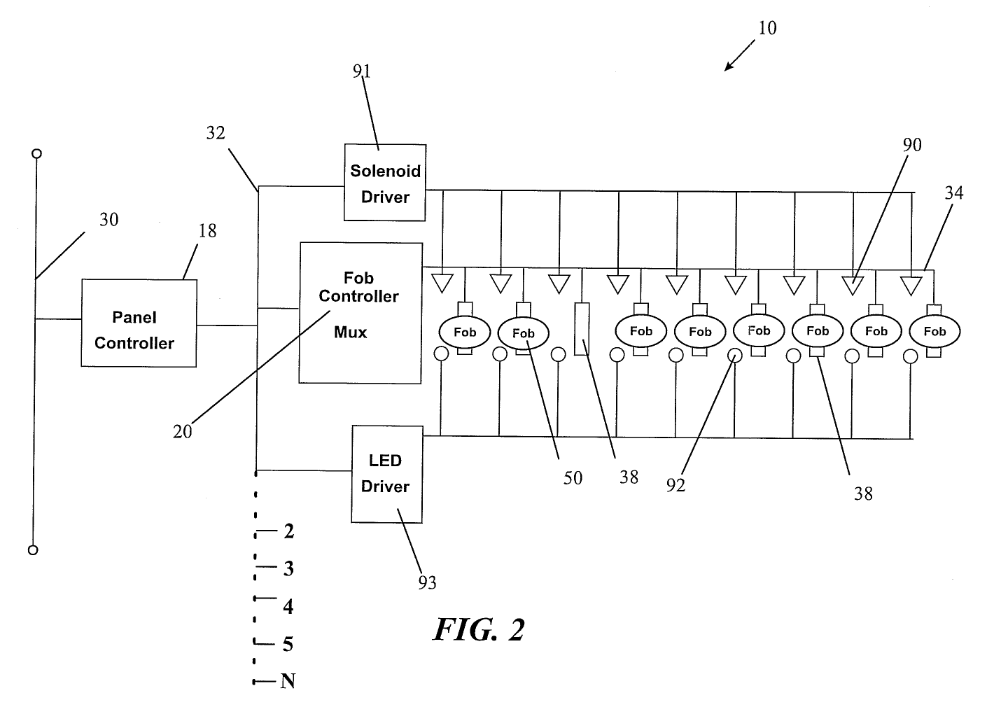

Referring to FIGS. 1 and 2, an asset management system 10 includes a system microprocessor 16, which is in communication with a host computer 12 through wired or wireless communication, and at least one panel controller 18 through a high-speed multi-drop communications bus 30 (i.e. RS-485, etc.). In the illustrated embodiment, each panel controller 18 controls a plurality of fob controller/multiplexers 20 through an I2C bus 32, which in turn each fob controller 20 controls eight connection ports 38, and by extension up to eight fobs 50. The panel controller 18 also controls at least one LED drive controller 93, and, preferably at least one solenoid drive controller 91, as illustrated in FIG. 2. The elements of the system form a distributed hierarchal structure. The connection ports 38 are preferably Universal Serial Bus (USB) ports. An I2C 2-wire bus 34 communicates a three bit address that specifies a particular connection port 38 having a known physical position. In the illustrated embodiment each panel controller 18 controls five fob controller multiplexers 20, for a total of forty connection ports 38. Similarly, the panel controller 18 controls forty Light Emitting Diode (LED) indicators via a multiplexed I2C LED driver, which are LEDs associated with a given connection port 18. An LED guide 92 is positioned proximate to the associated connection port 38, and the function of the LED guide 92 is specific to that connection port 38. The LED guide 92 is a visible enunciator that illuminates a specific position of a particular fob 50 when it is selected to be removed or, alternatively, if the connection port 38 has been designated as the location where a particular fob 50 is to be returned. The LED guide 92 is typically illuminated until the fob 50 or other asset is either removed or returned, whatever is appropriate for the management system. Each panel controller 18 can also control forty solenoids 90 for automatically locking/and unlocking a specific fob 50 plugged into a lockable connection port 38 via multiplexed I2C driver. All of the panel and fob controller 18,20 functions and communication functions are managed through a high speed serial communication 85 (wired or wireless) in communication with the host computer via transceiver 17. In the illustrated embodiment of FIG. 2 there is one panel controller 18 on a panel 80.

The panels 80 can be daisy-chained together through the common multi-drop serial bus, typically through a plurality of serially bussed electrical connectors 60 (i.e. RJ45, etc.). In the illustration of FIG. 1, three panels 80 are mounted on a rack 40 which is a physical platform for the panels 80.

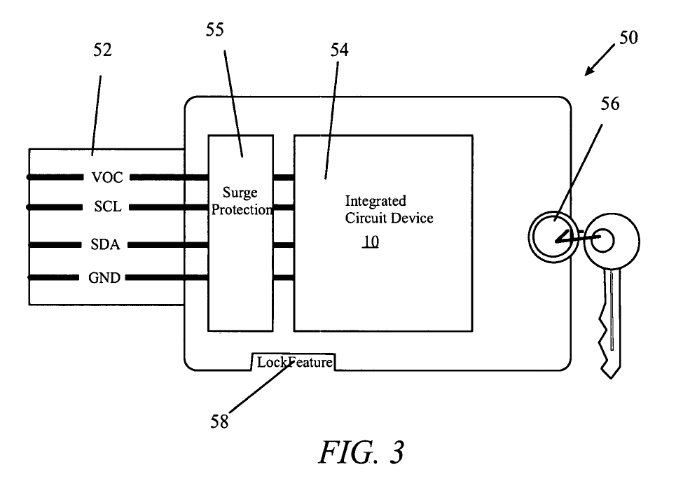

Referring to FIG. 3, each fob 50 has an integrated circuit 54, a USB form factor pluggable connector 52, and an assets ring 56 for attaching and retaining assets, such as a set of keys 58. The pluggable connector 52 is preferably an industry standard USB pluggable Form A factor. The preferable integrated circuit 54 is a low power high speed integrated circuit 54 that is capable of gaining and or retaining a unique identifier, and communicating to its respective fob controller 20 via a standard multiplexed I2C 2-wire serial communications bus interface, such as the I2C bus 34. Additionally, the fob 50 can include a surge protector 55 between the pluggable connector 52 and the integrated circuit 54. Further, the fob 50 includes an asset ring 56 which can be configured to attach to an asset 51, such as a key. Also, the fob 50 can include a locking groove 58 which can be engaged by the solenoid 90 to prevent the fob 50 from being removed from the connection port 38.

Referring back to FIGS. 1 and 2, the rack 40 (individually numbered 40a, 40b) enables backplane assembly. The rack 40 supports the controllers, buses, connectors, fobs and assets (i.e. keys) mounted on the panels 80; and an electrical interface 190 for powering the electrical components. In the illustrated embodiment, each panel controller 18 has a segment of the communications bus 30, where the communications bus 30 segment has a pair of electrical connectors 60 (i.e. RJ45, etc.) to link to additional panels 80 or to the system microprocessor 16 through a connection 26.

The rack 40 is typically mounted in a cabinet 81 or on a board. A board provides open access to the assets, and is typically in a secured room. When in the cabinet 81, the cabinet 81 is normally locked except when assets are being collected or returned. The cabinet 81 has a general position enunciator 83, such as an audible and visible signal that provides an approximate physical location of at least one selected asset. The host computer 12, communicating through the system processor 16 through the high speed serial communications bus 30, issues a general position enunciation when at least one asset, for instance a set of keys, is housed in that particular cabinet 81. The general position enunciator 83 is actuated, creating illumination from an exterior LED or beeping from a piezo buzzer, to indicate where the keys are housed. Alternatively if the asset is on a board, then the general position enunciator 83 enables a requester to identify which board is the physical location of the at least one selected asset.

The cabinet 81 can have an automated lock 89, and the computer typically also communicates to the cabinet 81 that its state is to change from a locked state to an unlocked state, and a striker is actuated unlocking the cabinet 81.

The I2C 2-wire bus 32,34 consists of a clock wire (e.g. SCL) and data wire (e.g. SDA). The fob controller 20 specifically manages the unique location of the plurality of fobs 50 using addressable locations, typically eight, where the address is conveyed in the form of three bit address (i.e., 000, 100, 010, 100, 001, 101, 011, 111), which in effect multiplexes the I2C 2-wire bus.

Referring to FIG. 1, the system microprocessor 16 (illustrated as 16a and 16b) actuates an alarm 87, for instance if a user accidentally unplugs a fob 50 not selected fob if assets are being collected, or actuates the alarm if the fob 50 having a returning asset is plugged into the wrong connection port 38.

Each panel controller 18 is an integrated circuit device such as a microprocessor, that has an I2C 2-wire communications bus interface 32,34, a serial universal asynchronous receiver transmitter (UART) and a programming configured to indicate a unique panel location with respect to the system microprocessor 16 and a plurality of panel controllers 18. The illustrated panel controllers 18 can utilize DIP switches 19 to select an address for a given panel controller 18. Further, theses interfaces 32,34 communicate commands and functions from the system microprocessor 16. The panel controller 18 serves as a means of collecting fob 50 identification information as well as other fob status.

In the case where a plurality of system microprocessors 16a,16b are used, such as when there are multiple racks, as illustrated in FIG. 1, one system microprocessor 16a serves as the master system microprocessor 16a and all subsequent microprocessors 16b (one shown) serve as slave controllers connected through a connection 28. In the illustrated embodiment, there are M racks 40, where M=2. The master and slave connections, connections to the racks 40, and all interconnections between panels can use industry standard category-5 Ethernet cables but is not limited to such cabling scheme.

The system microprocessor 16a can also contains a plurality of general purpose input and outputs (not shown) that may be utilized for a plurality of functions, such as, but not limited to, secure cabinet access methods, alarms, indicators, monitors, and sensors. Secure cabinet 81 access methods accommodated by the system microprocessors 16a,16b may include, but is not limited to, biometric scanning technologies, keypad interface, magnetic striped cards or remote control via host computer application control.

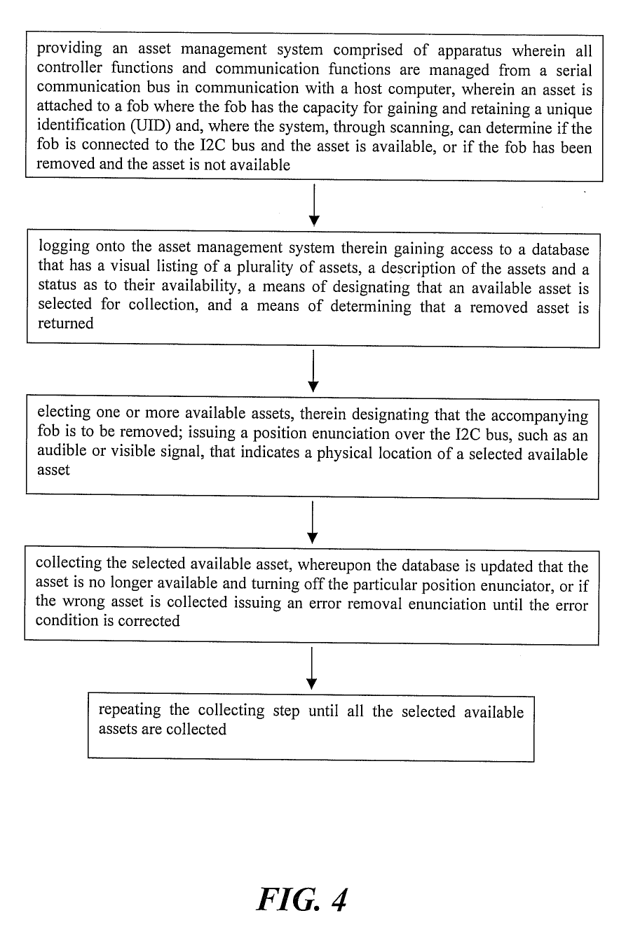

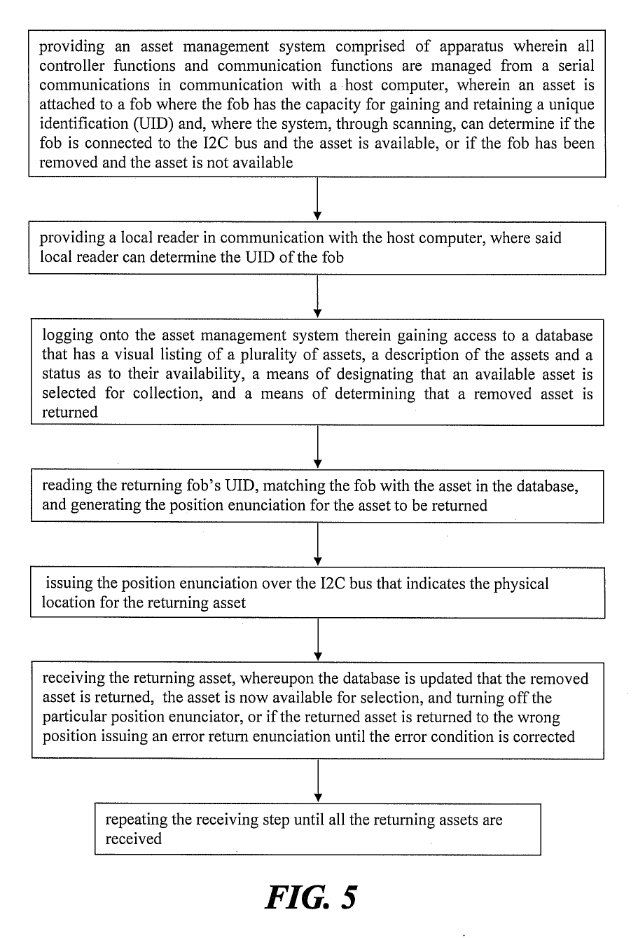

Referring to FIGS. 4 and 5, the method of the asset management system includes four steps: a) providing a method of entering assets, such as a set of keys, into the management system; b) providing a method of removing an assets; c) providing a method of returning an asset; and d) providing a method of deleting assets from the management system.

In the method of entering an asset, (i.e., a set of keys for a device having a unique number, such as a Vehicle Identification Number), the asset is physically connected to a fob. The fob is assigned a unique identifier (UID) which is retained, and the asset's description, such as the vehicle identification number (VIN), is entered into the database on the host computer.

The method of removing an asset includes the steps of: a requester logs into an asset management system including an apparatus wherein all controller functions and communication functions are managed from a wired or wireless communication link with a host computer, where upon recognition and approval by the computer, the computer grants the requester access to a database that has a visual listing of a plurality of assets, their description and their availability, a means of selecting an available asset and a means of determining that a removed asset is returned. The requestor selects one or more available assets, for instance where an asset is a set of keys that the requestor wishes to remove, whereupon the system is updated with the selection. The computer issues a general position enunciation, such as an audible and visible signal that provides the requester with an approximate physical location of at least one selected asset. For instance, where at least one set of keys is housed in a secured cabinet, an exterior LED is illuminated or a piezo buzzer issues a beep from the exterior of the particular cabinet where the keys are housed. Alternatively if the asset is on a board, unsecured by a cabinet, then the general position enunciation enables the requester to identify which board is the physical location of the at least one selected asset. In the case where the cabinet has an automated lock, the computer typically also communicates through a cabinet controller to the cabinet that its state is to change from a locked state to an unlocked state, and an actuated striker unlocks the cabinet. A requester on opening the first cabinet views available assets in that cabinet, where each available asset is attached to a fob, and the fob is plugged into a USB port, and each USB port has a fob guide that is a specific position enunciation, typically an LED adjacent to the USB, of the exact physical location of one of the selected assets. When the requestor pulls one of the selected available assets, the database is updated that the asset is no longer available, and the computer communicates through the system that the fob guide is to be turned off. If the wrong fob is unplugged, this is detected, and a fob error alarm goes off until the miss-pulled fob is re-plugged. The preferred system has a specific position solenoid, which locks the fob to the USB at all times except when the asset is selected for removal. After all of the selected available assets for that particular cabinet are pulled, the requester must shut the cabinet within a user specified timeframe (typically less than 1 minute), which then relocks and the general position enunciator for that particular cabinet is turned off. If the cabinet is not closed after pulling all the selected available assets within the time frame then a door-open alarm signal activates. If the cabinet is closed prior to pulling all of the selected available assets for that particular cabinet a warning-error alarm signal activates until correction is effected. The various alarms can issue as spoken instructions as to what is the reason for the alarm, or as a meaningful combination of tones and beeps, or as visual instructions, or a combination thereof. After closing the cabinet or pulling all the fobs on a board, if additional selected available assets need to be pulled the requester can then move to the next cabinet or board where there are still un-pulled selected assets. The process is repeated until all selected available assets have been collected. In the method, when there are a large number of assts/keys the Requestor is typically an individual who is responsible for keeping track of the assets, and in this capacity is a Proctor of the assts, therein limiting the number of individual who have actual access to the system. The Proctor would typically work in a secure protected area, and would have little or no direct contact with a Recipient of the asset.

The method of returning an asset includes the steps of: a Requestor, if logged out, logs into an asset management system including a host computer, where upon recognition and approval by the computer, the computer grants the Requestor access to a local host reader with a USB port, and a database that contains a visual listing of a plurality of assets, their description and their availability. The Requestor plugs the fob into the local reader, which reads the fob's unique ID which matches the fob with the asset in the database, and generates a general position enunciation and a specific position enunciation for the returning asset. If more than one asset is being returned, multiple fobs can be read, and the asset management system will sort the physical locations into at least one general position enunciation, so that requestor can efficiently return the assets, on a cabinet by cabinet-by-cabinet level or a board-by-board level. In the case of cabinets, the appropriate cabinets typically unlocked when they are enunciated with an illuminated exterior LED or a piezo buzzer. The Requestor returns the asset to the specific position, and the database is updated that the asset is has been returned and is available. If the Requestor plugs the fob into the wrong USB port an error alarm goes off until the miss-plugged fob is re-plugged into the correct USB port. After all of the returning assets for that particular cabinet are plugged-in, the Requestor must shut the cabinet within a user specified time frame (typically less than 1 minute), which then relocks and the general position enunciator for that particular cabinet is turned off. If the cabinet is not closed after plugging in all the returning assets within the time frame then a door-open alarm signal activates. If the cabinet is closed prior to plugging in all of the returning assets for that particular cabinet a warning-error alarm signal activates until a correction is effected. The various alarms can issue as spoken instructions as to what is the reason for the alarm, or as a meaningful combination of tones and beeps, or as visual instructions, or a combination thereof. After closing the cabinet or plugging-in all the fobs on a board, if additional returning assets need to be returned the requester can then move to the next cabinet or board where there are still un-plugged returning assets. The process is repeated until all returning assets have been returned.

The method of deleting assets from the asset management system includes the steps of: logging the Proctor into the database; selecting that the asset is going to be permanently removed from the panel, and that the key fob's UID is no longer associated with the asset; disconnecting the fob from the asset, where upon the fob is decommissioned until it is again fitted with a new asset; and updating the database that the asset is no longer under control of the system.

Typically, the step of associating a unique identity of the key fob with the key's unique number is operatively affected by writing to the key fob integrated circuit a unique identity value; the unique identity value is generated by the database. A centralized database on a network, through the host computer which is a member of the network, can track all of the assets, wherein the network can be a local WiFi network, a local area network (LAN) or a wide area network (WAN).

The asset management system along with the features described herein provides a distributed hierarchical architecture that takes all previous methodologies further in terms of efficiency in communications speed between the fob identification device and the system microprocessor without proprietary electronic devices. The invention also eliminates the need for proprietary identification devices, which creates dependency from a sole source thus preventing opportunities for cost efficiencies. The system increases speed and reduces errors. It enables the system to be expanded in a direct modular fashion using a non-proprietary cable, transceiver and a high-speed industry standard communications bus interface. The system increases overall system integrity, reliability, testability and ability to maintain and troubleshoot.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim is expressed as a means or step for performing a specified function, it is intended that such claim be construed to cover the corresponding structure, material, or acts described in the Specification and equivalents thereof, including both structural equivalents and equivalent structures.

What is claimed is:

1. An asset management system, said system comprising:
a system microprocessor in communication with a host computer;
a panel controller controlled by said system microprocessor through a communications bus in electrical communication on a panel;
a fob controller controlled by said panel controller through the communications bus;
a plurality of uniquely addressable connection ports selectable by the fob controller, where each connection port has a known physical position;
a plurality of fobs with an integrated circuit comprising a unique identifier, a universal serial bus pluggable connector that enables connection to a connection port, and a ring for attaching and retaining an asset;
a plurality of indicators controlled by the panel controller through the communications bus, wherein each of the plurality of indicators comprises a light emitting diode located proximate to an associated connection port of the plurality of uniquely addressable connection ports;
a rack comprising a physical platform for multiple panels; and
wherein all panel and fob controller functions and communication functions are managed from the multiplexed serial communications bus in communication with the host computer.

2. The asset management system according to claim 1, where said panel controller controls five fob controllers, and each fob controller has eight addressable connection ports.

3. The asset management system according to claim 1, where said panel controller actuates a solenoid, wherein said solenoid is configured to lock and unlock the fob to the connection port.

4. The asset management system according to claim 1, wherein a first panel is daisy chain connected to a second panel, wherein said second panel comprises connections to additional panels using a multi-drop serial input output pair connection.

5. The asset management system according to claim 4 wherein said first and second panels and the system microprocessor are housed in the rack.

6. The asset management system according to claim 5, wherein the asset management system comprises multiple racks, wherein the system microprocessor on one of the multiple racks comprises a master system microprocessor, and wherein the system microprocessor on each of the remaining racks of the multiple racks comprises a slave system microprocessor.

7. The asset management system according to claim 5, wherein the rack is located in a secured cabinet.

8. The asset management system according to claim 1, wherein the system microprocessor communicates with the host computer wirelessly.

9. The asset management system according to claim 1, wherein the host computer comprises a local fob reader, a biometric scanner, keypad interface, magnetic striped cards, remote control access devices for logging on the computer, and combinations thereof.

10. The asset management system according to claim 1, wherein said system further comprises a position enunciator configured to indicate a position of where an asset is to be collected or returned to a cabinet or a board of stored assets.

11. An asset management system for a plurality of keys for devices having a unique number, such as a vehicle identification number and descriptive language, said system comprising:
a system microprocessor in communication with a host computer;
a panel controller controlled by said system microprocessor through a serial bus in electrical communication on a panel;
a fob controller controlled by said panel controller through the serial bus;
a plurality of uniquely addressable connection ports selectable by the fob controller, where each connection port has a known physical position;
a plurality of fobs with an integrated circuit comprising a unique identifier, a universal serial bus pluggable connector configured to connect to a connection port of the plurality of uniquely addressable connection ports, and a key ring;
a plurality of light emitting diode indicators controlled by the panel controller through the serial bus, where one light emitting diode indicator of the plurality of light emitting diode indicators is located proximate to each connection port;
a rack comprising a physical platform for multiple panels;
a wireless connection between the system microprocessor and the host computer;
a database application running on the host computer that controls the system microprocessor and maintains identity information on the fobs, the users, the keys' associated vehicle identification number; and
a login mechanism for the host computer.

12. The asset management system as claimed in claim 11, wherein the login is mechanism comprises a biometric reader.

13. The asset management system as claimed in claim 1, further comprising multiple system microprocessors, wherein one system microprocessor is configured electronically as a master, and subsequent system microprocessors of the multiple system microprocessors are configured as slave controllers.

14. The asset management system as claimed in claim 11, wherein the database on the computer is synchronized with at least one other database on another computer over a network.

15. The asset management system as claimed in claim 1, wherein a plurality of system microprocessors communicate with a central computer running a database application.

16. A method for asset management, wherein the asset comprises keys, comprising the steps of:
providing an asset management system, wherein the asset management system comprises a high speed serial communications bus configured to enable communications between one or more controllers and a host computer, wherein an asset is attached to a fob comprising a capacity for gaining and retaining a unique identification and, wherein the asset management system is configured to determine if the fob is connected to the communications bus and the asset is available, and if the fob has been removed and the asset is not available;
logging onto the asset management system therein gaining access to a database comprising a visual listing of a plurality of assets, a description of the plurality of assets and a status as to availability of the plurality of assets, wherein the asset management system further comprises means of designating that an available asset is selected for collection, and a means of determining that a removed asset is returned;
selecting one or more available assets, therein designating that the accompanying fob of the one or more selected assets to be removed;
issuing a position enunciation over the communications bus comprising one of an audible signal, a visible signal, and combinations thereof, where the position enunciation indicates a physical location of one of the selected available assets;
collecting the selected available asset, whereupon the database is updated that the collected asset is no longer available and turning off the particular position enunciator;
if the wrong asset is collected, issuing an error removal enunciation until the error condition is corrected; and
repeating the collecting step until all the selected available assets are collected.

17. The method according to claim 16 further comprising the steps of:
providing a local reader in communication with the host computer, where said local reader can determine a unique identification of the fob;
reading the returning fob's unique identification;
matching the fob with the asset in the database;
generating the position enunciation for the asset to be returned;
issuing the position enunciation over the communications bus that indicates the physical location for the returning asset;
receiving the returning asset, whereupon the database is updated that the removed asset is returned, the asset is now available for selection;
turning off the particular position enunciator;
if the returned asset is returned to the wrong position, issuing an error return enunciation until the error condition is corrected; and
repeating the receiving step until all the returning assets are received.

18. The method according to claim 16, where the method is implemented under the control of a proctor.

19. The method as claimed in claim 16, wherein the fob unique identification is generated by a database application, and assigned to the fob.

20. The method as claimed in claim 16, wherein the host computer is a member of a network.
